(19) United States
(12) Patent Application Publication
(10) Pub. No.: US 2025/0229370 A1
(43) Pub. Date: Jul. 17, 2025

(54) DEVICE FOR FABRICATION OF A WELDMENT

(71) Applicants: Jeffrey E. YOWELL, Portville, NY (US); Mark Steven ANTES, Wellsville, NY (US); ARVOS LJUNGSTROM LLC, Wellsville, NY (US)

(72) Inventors: Jeffrey E. Yowell, Portville, NY (US); Mark S. Antes, Wellsville, NY (US)

(73) Assignee: ARVOS LJUNGSTROM LLC, Wellsville, NY (US)

(21) Appl. No.: 18/695,568

(22) PCT Filed: Jun. 30, 2023
(86) PCT No.: PCT/US2023/026718

§ 371 Date: Mar. 26, 2024

(51) Int. Cl. B23K 37/047

(52) U.S. Cl. CPC B23K 37/047

(57) ABSTRACT

A device for fabrication of a weldment includes a carrier that has a first end plate, a second end plate and a frame extending between and connected to the first end plate and the second end plate. The first end plate has a first opening formed therein and the second end plate has a second opening formed therein. The first opening and the second opening are configured to removably secure weldable parts therein. The device includes a track system fixedly mounted to a foundation and a carriage moveably mounted to the track system. The track system and carriage collectively include a plurality of rollers arranged in an arcuate path. The carrier is removably mounted on the carriage, and the carriage and/or the track system is configured to move along the arcuate path defined by the plurality of rollers.

### CROSS-REFERENCE TO RELATED APPLICATION

The instant application is a non-provisional application of, and claims priority to PCT Application No. PCT/US2023/026718, filed on Jun. 30, 2023, which is incorporated by reference in its entirety.

### FIELD

The present disclosure relates to a device for fabrication of a weldment and more particularly to a carrier that is configured to flip parts to be welded 180 degrees vertically and is mounted on a carriage that rides on a track system that moves the carrier in an arcuate path so that the parts to be welded together move relative to a welding head.

### BACKGROUND

Manufacturing large annular structures such the upper and lower steel rings of anode cages for offshore wind towers is a complex process due to the large diameter (e.g., greater than 10 meters) and heavy weight of the rings (400 to 900 kilos). Transport of these rings by road in a single piece is not feasible because the diameter is too large. Thus, for transport, it is desirable that the annular structure is prefabricated in arcuate segments which are individually transportable, preferably all loaded on the bed of a truck, for final assembly on site or at the dockside prior to shipment offshore, for example.

It has been determined that the central portion of the arcuate segments tend to distort during, manufacturing, transport, installation and/or operation. Moreover, manipulating, holding and fabrication of the arcuate segments is difficult because of their large size and heavy weight.

Chinese Utility Model No. CN206653107U discloses a conical shell of a rotation device that includes a bracing ring and a bearing installed on the bracing ring. The conical shell is configured to roll on turning rolls and is used for automatic welding of parts.

German Utility Model No. DE202014105950U1 discloses an apparatus for performing welding which includes a device for fixing, on a base body, a workpiece to be welded. The base body is rotatably mounted on a rotary bearing.

Chinese Utility Model No. CN208409004U discloses an assembly for welding an automobile rear-wheel cover plate. The assembly includes a welding clamp with a pedestal and clamp body and a semi-circular sliding rail installed on the pedestal.

Thus, there is a need for an improved arcuate segment and fabrication methods that addresses the foregoing problems.

### SUMMARY OF THE INVENTION

There is disclosed herein a device for fabrication of a weldment which includes a carrier that has a first end plate, a second end plate and a frame that extends between and connected to the first end plate and the second end plate. The first end plate has a first opening formed therein and the second end plate has a second opening formed therein. The first opening and the second opening are configured to removably secure weldable parts therein. A track system is fixedly mounted to a foundation and a carriage is moveably mounted to the track system. The track system and the carriage collectively include a plurality of rollers arranged in an arcuate path. The carrier is removably mounted on the carriage and the carriage and/or the track system is configured to move along the arcuate path defined by the plurality of rollers.

In some embodiments, the plurality of rollers includes a plurality of inboard rollers and a plurality of outboard rollers and wherein the arcuate path includes an inboard arcuate path defined by the plurality of inboard rollers and an outboard arcuate path defined by the plurality of outboard rollers.

In some embodiments, the plurality of rollers includes a plurality of first rollers and a plurality of second rollers and wherein the arcuate path includes a first arcuate path defined by the plurality of first rollers and second arcuate path defined by the plurality of second rollers.

In some embodiments, the first end plate has a first outer edge, and the second end plate has a second outer edge that both are configured for rolling the carrier on a surface about an axis of rotation that intersects center points of each of first end plate and the second end plate. Preferably the first outer edge and the second outer edge have an arcuate or circular contour.

In some embodiments, the frame includes first mounting surfaces that are configured to be seated on the carriage and/or second mounting surfaces that are configured to be seated on a stand. Preferably, the first mounting surfaces and the second mounting surfaces are located radially inward of the first outer edge and the second outer edge.

In some embodiments, the first opening is C-shaped and has first opposing side walls that terminate at a first base surface; and the second opening is C-shaped and has second opposing side walls that terminate at a second base surface. A first retainer system is positioned proximate the first base surface and a second retainer system is positioned proximate the second base surface. The first retainer system and the second retainer system each having a fastener removably secured thereto and is configured to removably clamp the weldable parts to the first base surface and the second base surface and between the first opposing side walls and between the second opposing side walls.

In some embodiments, a carriage drive system is in communication with the carriage and is configured to move the carriage along the arcuate path.

In some embodiments, the drive system is secured to the carriage, the track system or the foundation.

In some embodiments, the drive system includes a motor that is configured to rotate a drive roll that is positioned adjacent to an idler roll. The carriage has a drive rib that extends from an underside of a top-plate of the carriage. The drive rib is positioned between and is in frictional engagement with the drive roll and the idler roll.

In some embodiments, the carriage has an inboard support rib and an outboard support rib extending from an underside of a top-plate of the carriage. The inboard support rib is seated on and guided by the plurality of inboard rollers and the outboard support rib is seated on and guided by the plurality of outboard rollers.

In some embodiments, the carriage includes a protective skirt that extends from an underside of a top-plate of the carriage and which is configured to prevent access to the plurality of rollers.

In some embodiments, a plurality of weldable parts are removably mounted in the first opening and the second opening and a gusset strip is positioned on and extends outwardly from a respective edge of one of each of the plurality of weldable parts. The device includes an inboard welding unit configured to weld one of the gusset strips to an edge of a respective one of the plurality of weldable parts on an inboard side of the plurality of weldable parts as the carrier moves on the track system. In some embodiments, the device includes an outboard welding unit configured to weld one of the gusset strips to another edge of a respective one of the plurality of weldable parts on an outboard side of the plurality of weldable parts as the carrier moves on the track system. In some embodiments, the inboard welding unit and the outboard welding unit perform the welding simultaneously.

In some embodiments, the inboard and/or the outboard welding units include a flux recycling system selectively positioned adjacent to the gusset strips and configured to collect welding flux dispensed by the inboard welding unit and/or and the outboard welding unit.

In some embodiments, the carriage and/or the plurality of weldable parts have an arcuate shape.

There is also disclosed herein a method of welding and staging that includes providing a device for fabrication of a weldment which includes a carrier that has a first end plate, a second end plate and a frame that extends between and connected to the first end plate and the second end plate. The first end plate has a first opening formed therein and the second end plate has a second opening formed therein. The first opening and the second opening are configured to removably secure weldable parts therein. A track system is fixedly mounted to a foundation and a carriage is moveably mounted to the track system. The track system and the carriage collectively include a plurality of rollers arranged in an arcuate path. The carrier is removably mounted on the carriage and the carriage and/or the track system is configured to move along the arcuate path defined by the plurality of rollers. The method includes providing one or more gusset strips and one or more weldable parts. The method includes welding a first gusset-edge of a first gusset strip of the gusset strips to a first weld-edge of a first weldable part of the plurality of weldable parts with the first gusset-edge facing upward and the first weld-edge facing downward as the carriage moves the plurality of weldable parts along the inboard arcuate path and the outboard arcuate path.

In some embodiments, the method includes removing the carrier from the carriage after the welding and while the plurality of weldable parts is secured in the carrier, rolling the carrier 180 degrees about the axis of rotation so that the first gusset-edge of the first gusset strip faces downward. The method includes replacing the carrier on the carriage with a second gusset-edge of a second gusset strip of the gusset strips that faces upwards, with the second-gusset edge being opposite the first gusset-edge. The method includes welding the second gusset-edge to a second weld-edge of a second weldable part of the plurality of weldable parts, the second weld-edge being opposite the first weld-edge. The method includes performing the welding as the carriage moves the plurality of weldable parts along the inboard arcuate path and the outboard arcuate path.

### BRIEF DESCRIPTION OF THE DRAWINGS

FIG. 1 is a perspective end view of a carrier for fabrication of a weldment shown in a ready to be loaded position;

FIG. 2 is a perspective front view of the carrier for fabrication of a weldment shown in a ready to be loaded position;

FIG. 3 is a perspective front view of the carrier for fabrication of a weldment shown in an upright position with parts to be welded mounted therein and the carrier mounted on a carriage for arcuate movement on a track;

FIG. 4 is a perspective rear view of the carrier for fabrication of a weldment shown in an upright position with parts to be welded mounted therein and the carrier mounted a carriage for arcuate movement on a track;

FIG. 5 is an enlarged perspective view of a portion of the carrier of FIG. 3 shown with a flux collection device;

FIG. 6 is an enlarged perspective view of a portion of the carrier of FIG. 3 shown with another flux collection device;

FIG. 7 is a perspective rear view of the carrier for fabrication of a weldment shown in an upright and unloaded position;

FIG. 8 is a top perspective view of the track and driver system for the carrier of FIG. 4;

FIG. 9 is a bottom perspective view of an underside of the carriage of FIG. 3;

FIG. 10 is a front perspective view of the carrier of FIG. 1, shown in an upright position with the parts to be welded mounted therein;

FIG. 11 is rear perspective view of the carrier of FIG. 1, shown in an upright position with the parts to be welded mounted therein; and

FIG. 12 is a front perspective view of the carrier of FIG. 10, shown in an upright position with the parts to be welded mounted therein and rotated 180 about a horizontal axis and 180 degrees about a vertical axis compared to the carrier of FIG. 10.

### DETAILED DESCRIPTION

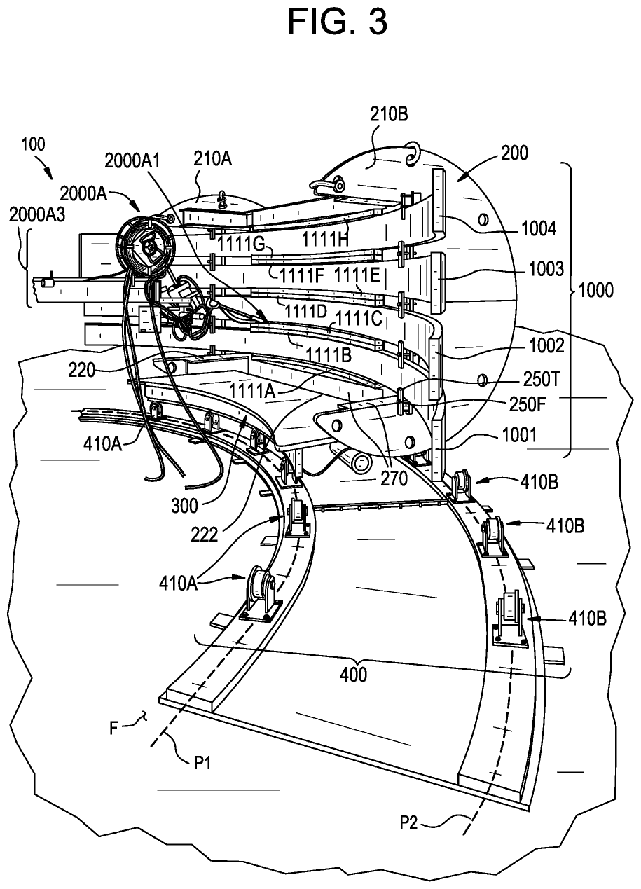

As shown in FIG. 3, a device for fabrication of a weldment 1000 is generally designated by the numeral 100. As described herein, the device 100 includes a carrier 200, a track system 400 and a carriage 300, all manufactured from a metallic material, such as carbon steel.

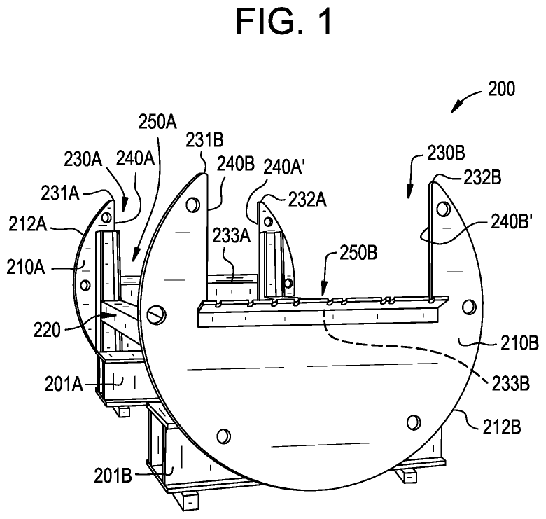

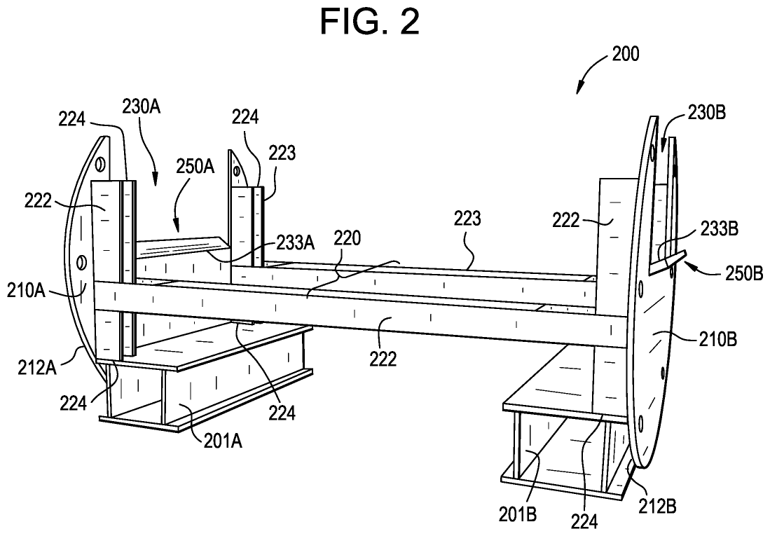

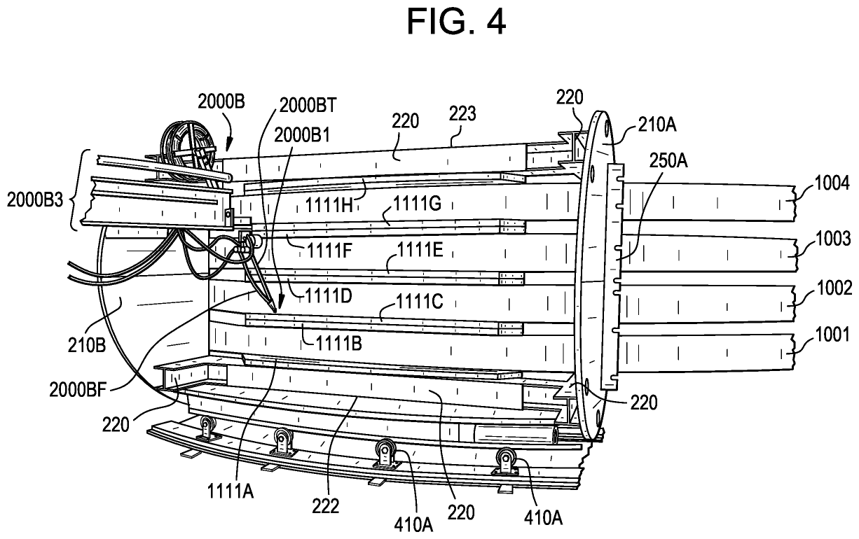

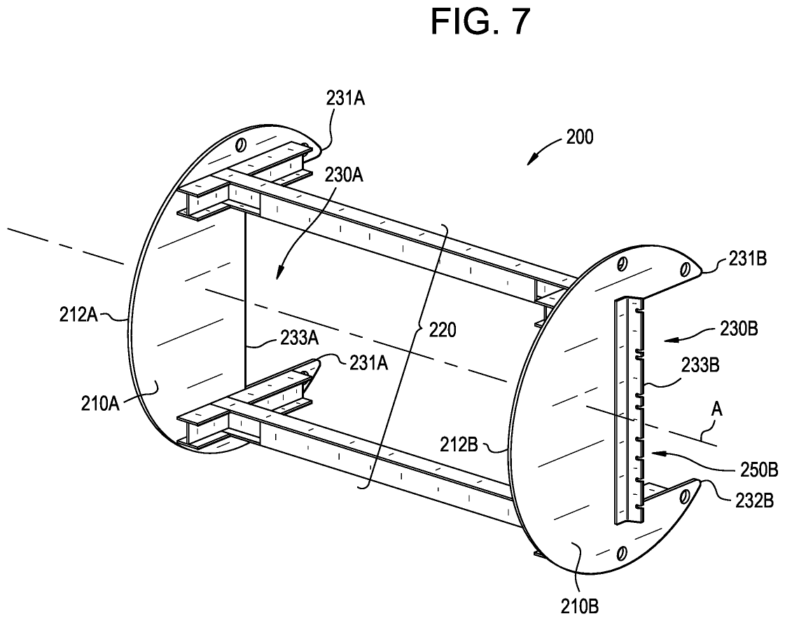

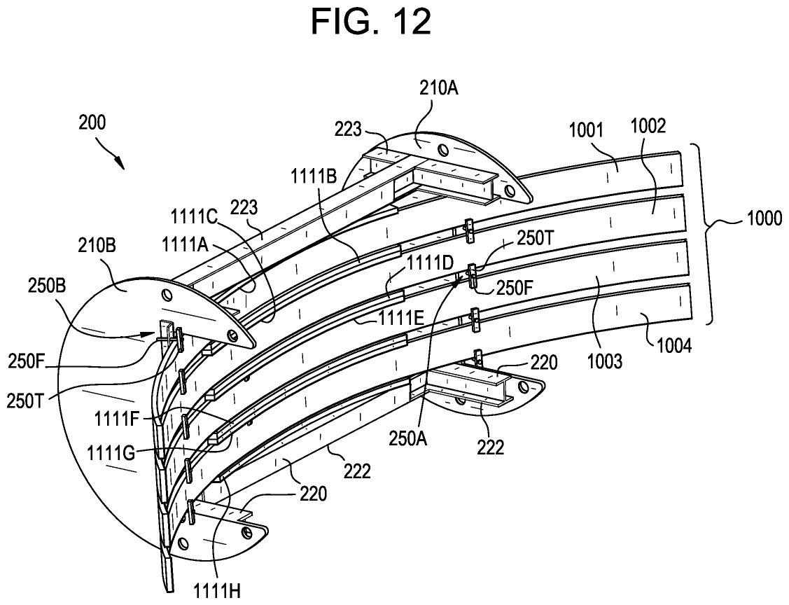

As shown in FIGS. 1, 2 and 7, the carrier 200 has a first end plate 210A, a second end plate 210B and a frame 220 that extends between and is connected to the first end plate 210A and the second end plate 210B. The frame 220 includes a mounting surface 222 that is seated on an upper surface 300M of the carriage 300 as shown in FIG. 4. The frame 220 includes a mounting surface 223 that is configured to be seated on the upper surface 300M of the carriage 300 when the carrier 200 is in the orientation as shown in FIG. 12. The frame 220 includes mounting surfaces 224 that are seated on stands 201A, 201B as shown in FIG. 2. The frame 220 includes mounting surfaces 224′ that are configured to be seated on the stands 201A, 201B when the carrier is inverted from the orientation as shown in FIG. 2. In some embodiments, the mounting surfaces 222, 223, 224, 224′ are located radially inward of the first outer edge 212A and the second outer edge 212B so as not to interfere with the ability to roll the carrier 200 on a surface, such as a fabrication shop floor.

The first end plate 210A has a first opening 230A formed therein and the second end plate 210B has a second opening 230B formed therein. The first opening 230A and the second opening 230B are configured to removably secure weldable parts 1000 therein, as discussed further herein.

The first opening 230A has two opposing (e.g., parallel) side walls, for example, a first side wall 240A that extends inward from a point 231A on an edge 212A of the first end plate 210A and terminates at a first base surface 233A that is substantially perpendicular to the first side wall 240A; and a second side wall 240A′ that extends inward from a point 232A on an edge 212A of the first end plate 210A and terminates at the first base surface 233A that is substantially perpendicular to the second side wall 240A′. That is, in some embodiments, the first opening 230A is a rectangular cut in the circular first end plate 210A.

The second opening 230B has two opposing (e.g., parallel) side walls, for example, a first side wall 240B that extends inward from a point 231B on an edge 212B of the second end plate 210B and terminates at a second base surface 233B that is substantially perpendicular to the first side wall 240B; and a second side wall 240B′ that extends inward from a point 231B on an edge 212B of the second end plate 210A and terminates at the second base surface 233B that is substantially perpendicular to the second side wall 240B′. That is, in some embodiments, the second opening 230B is a rectangular cut in the circular second end plate 210B.

The first opening 230A is C-shaped and has first opposing side walls 240A, 240A′ that terminate at a first base surface 233A; and the second opening 230B is C-shaped and has second opposing side walls 240B, 240B′ that terminate at a second base surface 233B. A first retainer system 250A is positioned proximate the first base surface 233A; and a second retainer system 250B is positioned proximate the second base surface 233B. The first retainer system 250A and the second retainer system 250B each include a metallic (e.g., steel) strip with an L-shaped cross section and having a plurality of slots extending therein along a longitudinal edge thereof. The steel strip of the first retainer system 250A is secured to (e.g., welded or bolted to) the first end plate 210A adjacent to the first base surface 233A. The steel strip of the second retainer system 250B is secured to (e.g., welded or bolted to) the second end plate 210B adjacent to the second base surface 233B.

The first retainer system 250A and the second retainer system 250B each include a plurality of fastener assemblies (e.g., a plurality of threaded rods or bolts 250F, a clamp 250T, threaded on to the threaded rod, a bolt head and/or a nut threaded on to the threaded rod). Each of the fastener assemblies is removably secured to the each of the first retainer system 250A and the second retainer system 250B. For example, each of the threaded rods 250F is removably fitted (e.g., slid into) a respective one of the slots and is configured to removably clamp the weldable parts 1000 by threading the clamp 450T over one or two of the weldable parts 1000 and onto the threaded rod 450F. Thus, the first retainer system 250A and the second retainer system 250B removably clamp the weldable parts 1000 to the first base surface 233A and the second base surface 233B and between the first opposing side walls 240A, 240A′ and between the second opposing side walls 240B, 240B′, respectively.

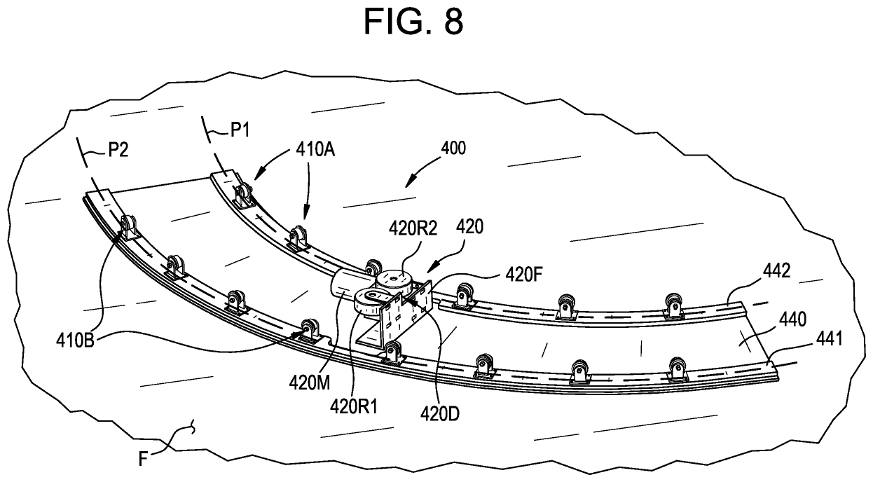

As shown in FIGS. 3 and 8, the track system 400 is fixedly mounted to a foundation F and includes a plurality of inboard rollers 410A mounted on an inboard arcuate strip (e.g., metallic plate) 442 and arranged in an inboard arcuate path P1 and a plurality of outboard rollers 410B mounted on an outboard arcuate strip 441 (e.g., metallic plate) and arranged in an outboard arcuate path P2. The inboard arcuate strip 442 and the outboard arcuate strip 441 are secured to an arcuate base plate 440 which is mounted to the foundation F. While it is shown and described that the plurality of inboard rollers 410A are mounted on an inboard arcuate strip 442 and the plurality of outboard rollers 410B mounted on an outboard arcuate strip 441, the present invention is not limited in this regard as the plurality of inboard rollers 410A and the plurality of outboard rollers 410B may be mounted directly to the foundation F.

The first end plate 210A has a first outer edge 212A and the second end plate 210B has a second outer edge 212B that both are configured for rolling the carrier 200 on a surface (e.g., a fabrication shop floor) about an axis A of rotation that intersects center points of each of first end plate 210A and the second end plate 210B. For example, the first outer edge 212A and the second outer edge 212B have an arcuate or circular contour or a contour with multiple flat surfaces.

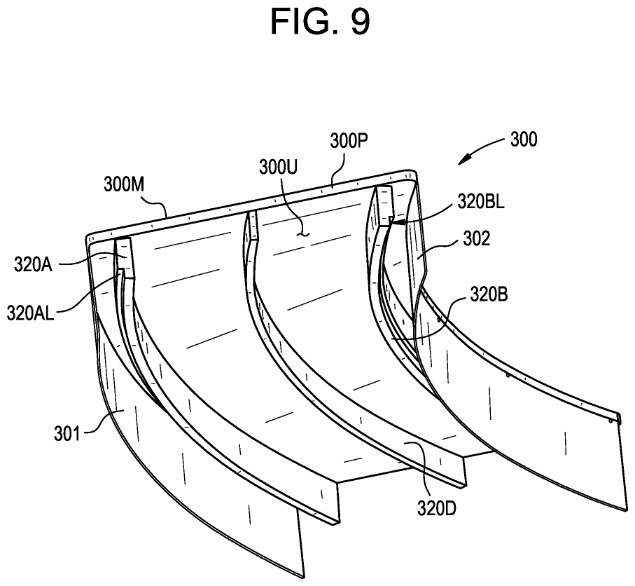

As shown in FIGS. 3 and 8, the track system 400 includes a carriage drive system 420 that is secured to the track system 400, that is in communication with the carriage 300 and is configured to move the carriage 300 along the inboard arcuate path P1 and the outboard arcuate path P2. The carriage drive system includes a motor 420M mounted to a frame 420F. The motor 420M rotates a drive roll 420R2 that is rotabably mounted to the frame 420F. The carriage drive system 420 includes an idler roll 420R1 that is rotatably mounted to the frame 420F and is located adjacent to the drive roll 420R2. The carriage 300 has a drive rib 320D that extends from an underside 300U of a top-plate 300P of the carriage 300, as shown in FIG. 9. The drive rib 320D is positioned between and in frictional engagement with the drive roll 420R2 and the idler roll 420R1. While the carriage drive system 420 is shown and described as being secured to the track system 400, the present disclosure is not limited in this regard as other drive configurations are also viable including but not limited to a drive system secured to the carriage 300, a side mounted drive system or a foundation mounted drive system. Thus, the drive system 420 is secured to the carriage 300, the track system 400 or the foundation F.

As shown in FIG. 3, the carriage 300 is moveably mounted to the track system 400. The carrier 200 is removably mounted on the carriage 300. The carriage 300 is configured to move along the inboard arcuate path P1 and the outboard arcuate path P2.

As shown in FIG. 9, the carriage 300 has an inboard support rib 320B and an outboard support rib 320A that extend from an underside 300U of a top-plate 300P of the carriage 300. The inboard support rib 320B is seated on and guided by the plurality of inboard rollers 410A and the outboard support rib 320A is seated on and guided by the plurality of outboard rollers 410B. While it is shown and described that the inboard rollers 410A and the outboard rollers 410B arranged to the track system 400 which is fixedly mounted to a foundation F, the present invention is not limited in this regard, as the inboard rollers 410A and the outboard rollers 410B may be mounted on the carriage 300 and ride in slots in the track system 400. In some embodiments, the carriage 300 includes a protective skirt 301, 302 that extends from the underside 300U of the top-plate 300P of the carriage 300. The protective skirt 301, 302 is a safety feature to protect personal by preventing inadvertent access to the plurality of inboard rollers 410A the plurality of outboard rollers 410B. The carriage (300) is moveable in an arc of about 30 degrees along the inboard arcuate path (P1) and the outboard arcuate path (P2).

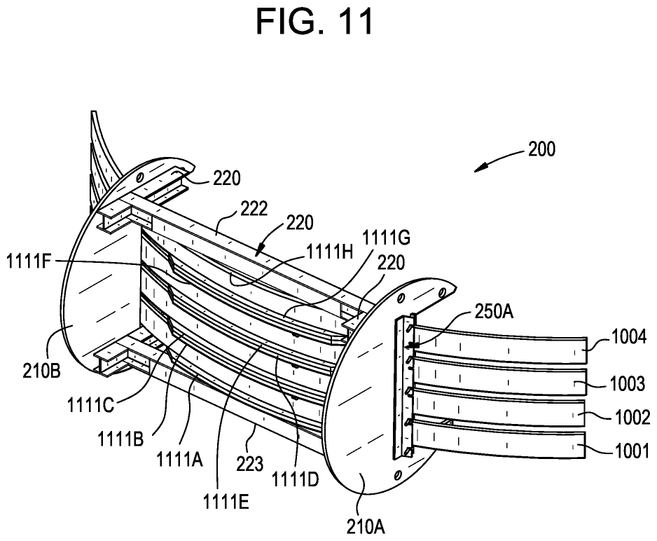

As shown in FIGS. 3, 10 and 11, the carrier 200 four weldable parts 1001, 1002, 1003, 1004 (e.g., 90-degree arcuate metallic segments of an unassembled anode ring) removably mounted in the first opening 230A and the second opening 230B and gusset strips 1111A, 1111B, 1111C, 1111D, 1111E, 1111F, 1111G, 1111H abutting each of the four weldable parts 1001, 1002, 1003, 1004. The gusset strip 1111A is positioned below and on a lower edge of the weldable part 1001. The gusset strip 1111B is positioned above and on an upper edge of the weldable part 1001. The gusset strip 1111C is positioned below and on a lower edge of the weldable part 1002. The gusset strip 1111D is positioned above and on an upper edge of the weldable part 1002. The gusset strip 1111E is positioned below and on a lower edge of the weldable part 1003. The gusset strip 1111F is positioned above and on an upper edge of the weldable part 1003. The gusset strip 1111G is positioned below and on a lower edge of the weldable part 1004. The gusset strip 1111H is positioned above and on an upper edge of the weldable part 1004. The gusset strips 1111A, 1111B, 1111C, 1111D, 1111E, 1111F, 1111G, 1111H are positioned on and extend outwardly from the respective weldable parts.

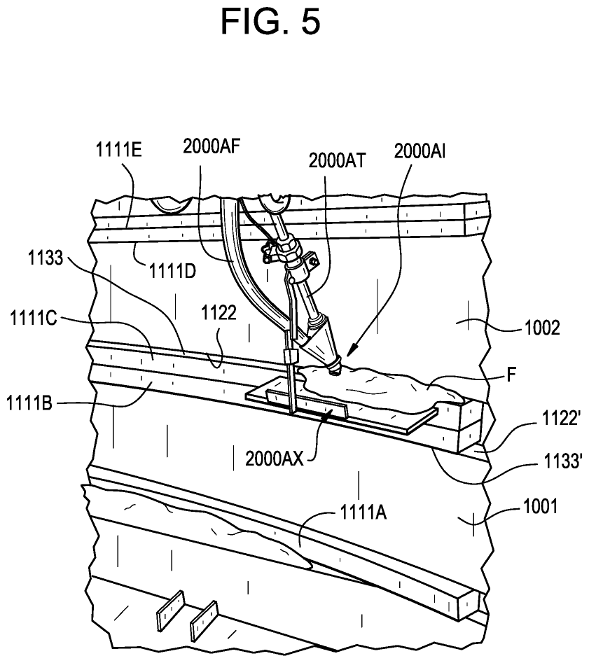

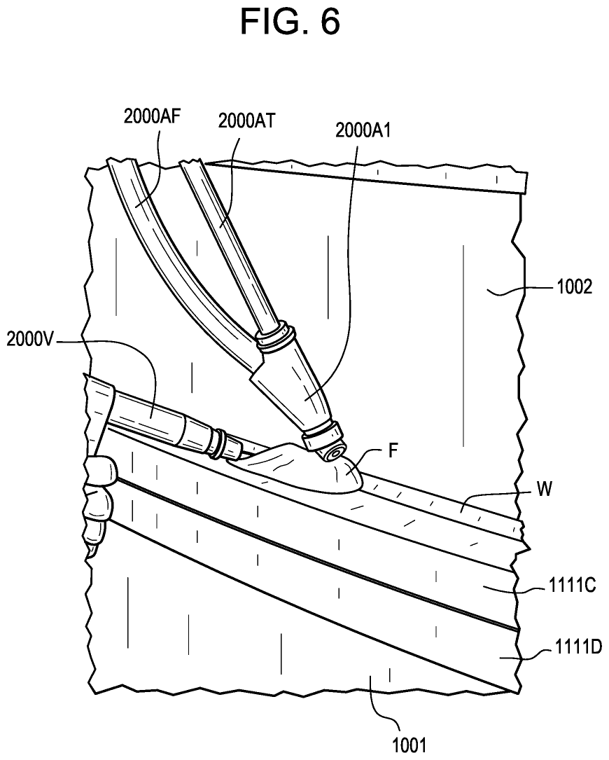

As shown in FIGS. 3 and 5-6, an inboard welding unit 2000A (e.g., a solid wire submerged arc welding system, a tungsten inert gas or flux wire feed welding system) that has a welding head 2000A1 that is in communication with a weld wire feeder 2000AT and a flux or inert gas feeder 2000AF is configured to weld the respective gusset strips 1111A, 1111B, 1111C, 1111D, 1111E, 1111F, 1111G, 1111H to the weldable part on an inboard side (see FIG. 3) of the weldable part as the carrier 300 moves on the track system 400.

As shown in FIG. 4, an outboard welding unit 2000B (e.g., a tungsten inert gas or flux wire feed welding system) that has a welding head 2000B1 that is in communication with a weld wire feeder 2000BT and a flux or inert gas feeder 2000BF, and is configured to weld the gusset strips 1111A, 1111B, 1111C, 1111D, 1111E, 1111F, 1111G, 1111H to the respective weldable part 1001, 1002, 1003, 1004 on an outboard side (see FIG. 4) of the weldable part as the carrier 300 moves on the track system 400. Referring to FIGS. 4-6, in some embodiments, the inboard welding unit 2000A and/or the outboard welding unit 2000B includes a flux recycling system 2000AX, 2000V positioned adjacent to the gusset strip and configured to collect welding flux F dispensed by the inboard welding unit 2000A and the outboard welding unit 2000B adjacent to the weld. In some embodiments, the flux recycling system 2000AX is a shelf mounted to the welding head 2000A1, 2000B1. In some embodiments, the flux recycling system 2000V is a vacuum or suction device.

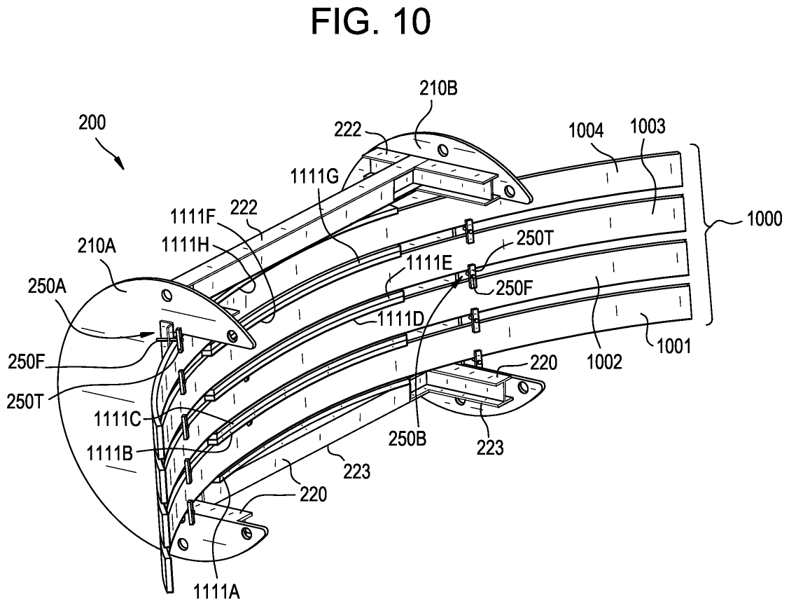

There is disclosed herein a method of welding and staging which includes providing the device 100, at least one welding unit 2000A, 2000B, a gusset strip 1111A, 1111B, 1111C, 1111D, 1111E, 1111F, 1111G, 1111H and a weldable part 1001, 1002, 1003, 1004. For example, the method includes welding a first gusset-edge 1133 of the gusset strip 1111C to a first weld-edge 1133 of the weldable part 1002 with the first gusset-edge 1133 facing upward and the first weld-edge 1122 of the weldable part 1002 facing downward, as the carriage 300 moves the weldable parts 1001, 1002, 1003 and 1004 along the inboard arcuate path P1 and the outboard arcuate path P2. The method includes, removing the carrier 200 from the carriage 300 after the welding and while the weldable parts are secured in the carrier 200. The method includes rolling the carrier 200 180 degrees about a horizontal axis A of rotation that intersects center points of each of first end plate 210A and the second end plate 210B, so that the first gusset-edge 1133 of the gusset strip 1111C is facing downward. The rolling about the horizontal axis A and rotating about a vertical axis B, changes the orientation of the carrier 200 from the orientation shown in FIG. 10 to that orientation shown in FIG. 12. The method includes replacing the carrier 200 on the carriage 300 with a second gusset-edge 1133′ of gusset strip 1111B facing upwards, the second-gusset edge 1133′ being opposite the first gusset-edge 1133. The method includes welding the second gusset-edge 1133′ to a second weld-edge 1122′ of the weldable part 1001, the second weld-edge 1133′ being opposite the first weld-edge 1133, as the carriage 300 moves the weldable parts 1001, 1002, 1003 and 1004 along the inboard arcuate path P1 and the outboard arcuate path P2. In some embodiments, both inboard and outboard sides of the gusset strip are simultaneously welded to the opposite sides of the weldable part, with two weld units.

The following clauses that are listed as items represent embodiments of the present invention.

Item 1. A device (100) for fabrication of a weldment, the device (100) comprising:
a carrier (200) comprising a first end plate (210A), a second end plate (210B) and a frame (220) extending between and connected to the first end plate (210A) and the second end plate (210B), the first end plate (210A) having a first opening (230A) formed therein and the second end plate (210B) having a second opening (230B) formed therein, the first opening (230A) and the second opening (230B) being configured to removably secure weldable parts (1000) therein; a track system (400) fixedly mounted to a foundation (F) and comprising a plurality of inboard rollers (410A) arranged in an inboard arcuate path (P1) and a plurality of outboard rollers (410B) arranged in an outboard arcuate path (P2); and
a carriage (300) moveably mounted to the track system (400), the carrier (200) being removably mounted on the carriage (300), and the carriage (300) being configured to move along the inboard arcuate path (P1) and the outboard arcuate path (P2).

Item 2. The device (100) of item 1, wherein the first end plate (210A) has a first outer edge (212A) and the second end plate (210B) has a second outer edge (212B) that both are configured for rolling the carrier (200) on a surface about an axis (A) of rotation that intersects center points of each of first end plate (210A) and the second end plate (210B), and preferably the first outer edge (212A) and the second outer edge (212B) have an arcuate or circular contour.

Item 3. The device (100) of item 1, wherein the frame (220) comprises first mounting surfaces (222, 223) that are configured to be seated on the carriage (300) or second mounting surfaces (224, 224′) that are configured to be seated on a stand (201A, 201B), and preferably the first mounting surfaces (222, 223) and the second mounting surfaces (224, 224′) are located radially inward of the first outer edge (212A) and the second outer edge (212B).

Item 4. The device (100) of item 1, wherein
the first opening (230A) is C-shaped and has first opposing side walls (240A, 240A′) that terminate at a first base surface (233A) and the second opening (230B) is C-shaped and has second opposing side walls (240B, 240B′) that terminate at a second base surface (233B), and
a first retainer system (250A) is positioned proximate the first base surface (233A) and a second retainer system (250B) is positioned proximate the second base surface (233B), the first retainer system (250A) and the second retainer system (250B) each having a fastener (250F, 250T) removably secured thereto and being configured to removably clamp the weldable parts (1000) to the first base surface (233A) and the second base surface (233B) and between the first opposing side walls (240A, 240A′) and between the second opposing side walls (240B, 240B′).

Item 5. The device (100) of item 1, wherein a carriage drive system (420) is in communication with the carriage (300) configured to move the carriage (300) along the inboard arcuate path (P1) and the outboard arcuate path (P2).

Item 6. The device (100) of item 5, wherein the drive system (420) is secured to the carriage (300), the track system (400) or the foundation (F).

Item 7. The device (100) of item 5, wherein the drive system comprises a motor (420M) configured to rotate a drive roll (420R2) that is positioned adjacent to an idler roll (420R1), the carriage has a drive rib (320D) extending from an underside (300U) of a top-plate (300P) of the carriage (300), and the drive rib (320D) is positioned between and in frictional engagement with the drive roll (420R2) and the idler roll (420R1).

Item 8. The device (100) of item 1, wherein the carriage (300) has an inboard support rib (320B) and an outboard support rib (320A) extending from an underside (300U) of a top-plate (300P) of the carriage (300), the inboard support rib (320B) being seated on and guided by the plurality of inboard rollers (410A) and the outboard support rib (320A) being seated on and guided by the plurality of outboard rollers (410B).

Item 9. The device (100) of item 1, wherein the carriage (300) comprises a protective skirt (301, 302) extending from an underside (300U) of a top-plate (300P) of the carriage (300) and configured to prevent access to the plurality of inboard rollers (410A) the plurality of outboard rollers (410B).

Item 10. The device (100) of item 1, wherein a plurality of weldable parts (1001, 1002, 1003, 1004) are removably mounted in the first opening (230A) and the second opening (230B) and gusset strips (1111A, 1111B, 1111C, 1111D, 1111E, 1111F, 1111G, 1111H) positioned on and extending outwardly from the plurality of weldable parts (1001, 1002, 1003, 1004), an inboard welding unit (2000A) configured to weld the gusset strips (1111A, 1111B, 1111C, 1111D, 1111E, 1111F, 1111G, 1111H) to the plurality of weldable parts (1001, 1002, 1003, 1004) on an inboard side of the plurality of weldable parts (1001, 1002, 1003, 1004) as the carrier (300) moves on the track system (400), and wherein an outboard welding unit (2000B) is configured to weld the gusset strips (1111A, 1111B, 1111C, 1111D, 1111E, 1111F, 1111G, 1111H) to the plurality of weldable parts (1001, 1002, 1003, 1004) on an outboard side of the plurality of weldable parts (1001, 1002, 1003, 1004) as the carrier (300) moves on the track system (400).

Item 11. The device (100) of item 10, further comprising a flux recycling system (2000AX), 2000V) positioned adjacent to the gusset strips (1111A, 1111B, 1111C, 1111D, 1111E, 1111F, 1111G, 1111H) and configured to collect welding flux (F) dispensed by the inboard welding unit (2000A) and the outboard welding unit (2000B).

Item 12. The device (100) of item 1, wherein the carriage (300) and the plurality of weldable parts (1001, 1002, 1003, 1004) have an arcuate shape.

Item 13. The device (100) of item 1, wherein the carriage (300) is moveable in an arc of about 30 degrees along the inboard arcuate path (P1) and the outboard arcuate path (P2).

Item 14. A method of welding and staging comprising:
providing the device (100) of any of the preceding items, at least one weld unit (2000A, 2000B), the gusset strips (1111A, 1111B, 1111C, 1111D, 1111E, 1111F, 1111G, 1111H) and the plurality of weldable parts (1001, 1002, 1003, 1004); and
welding a first gusset-edge (1133) of a first gusset strip (1111C) of the gusset strips (1111A, 1111B, 1111C, 1111D, 1111E, 1111F, 1111G, 1111H) to a first weld-edge (1122) of a first weldable part (1002) of the plurality of weldable parts (1001, 1002, 1003, 1004) with the first gusset-edge (1133) facing upward and the first weld-edge (1122) facing downward as the carriage (300) moves the plurality of weldable parts (1001, 1002, 1003, 1004) along the inboard arcuate path (P1) and the outboard arcuate path (P2).

Item 15. The method of claim 14, further comprising:
while the plurality of weldable parts (1001, 1002, 1003, 1004) is secured in the carrier (200), removing the carrier (200) from the carriage (300) after the welding;
rolling the carrier (200) 180 degrees about the axis (A) of rotation so that the first gusset-edge (1133) of the first gusset strip (1111C) faces downward;
replacing the carrier (200) on the carriage (300) with a second gusset-edge (1133′) of a second gusset strip (1111B) of the gusset strips (1111A, 1111B, 1111C, 1111D, 1111E, 1111F, 1111G, 1111H) that faces upwards, the second-gusset edge (1133′) being opposite the first gusset-edge (1133); and
welding the second gusset-edge (1133′) to a second weld-edge (1122′) of a second weldable part of the plurality of weldable parts (1001, 1002, 1003, 1004), the second weld-edge (1122′) being opposite the first weld-edge (1122), as the carriage (300) moves the plurality of weldable parts (1001, 1002, 1003, 1004) along the inboard arcuate path (P1) and the outboard arcuate path (P2).

As will be apparent to those skilled in the art, various modifications, adaptations, and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

Terms that refer to direction or position, i.e., vertical, horizontal, upper, lower, etc., are used for convenience for the reader and are not meant to limit the structure or function of the invention in any manner unless specifically stated herein.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

1-15. (canceled)

16. A device for fabrication of a weldment, the device comprising:
a carrier comprising a first end plate, a second end plate and a frame extending between and connected to the first end plate and the second end plate, the first end plate having a first opening formed therein and the second end plate having a second opening formed therein, the first opening and the second opening being configured to removably secure weldable parts therein;
a track system suitable for being fixedly mounted to a foundation and a carriage moveably mounted to the track system; and
with the track system and carriage collectively comprising at least one plurality of rollers arranged in at least one arcuate path;
wherein the carrier is removably mounted on the carriage, and the carriage is configured to move relative to the track system along the at least one arcuate path defined by the at least one plurality of rollers.

17. The device of claim 16, wherein the at least one plurality of rollers comprises a plurality of inboard rollers and a plurality of outboard rollers and wherein the at least one arcuate path comprises an inboard arcuate path defined by the plurality of inboard rollers and an outboard arcuate path defined by the plurality of outboard rollers.

18. The device of claim 16, wherein the first end plate has a first outer edge and the second end plate has a second outer edge that both are configured for rolling the carrier on a surface about an axis of rotation that intersects center points of each of first end plate and the second end plate, and preferably the first outer edge and the second outer edge have an arcuate or circular contour.

19. The device of claim 16, wherein the frame comprises first mounting surfaces that are configured to be seated on the carriage or second mounting surfaces that are configured to be seated on a stand, and preferably the first mounting surfaces and the second mounting surfaces are located radially inward of the first outer edge and the second outer edge.

20. The device of claim 16, wherein
the first opening is C-shaped and has first opposing side walls that terminate at a first base surface and the second opening is C-shaped and has second opposing side walls that terminate at a second base surface, and
a first retainer system is positioned proximate the first base surface and a second retainer system is positioned proximate the second base surface, the first retainer system and the second retainer system each having a fastener removably secured thereto and being configured to removably clamp the weldable parts to the first base surface and the second base surface and between the first opposing side walls and between the second opposing side walls.

21. The device of claim 16, wherein a carriage drive system is in communication with the carriage and is configured to move the carriage along the at least one arcuate path.

22. The device of claim 21, wherein the drive system is secured to the carriage, the track system or the foundation.

23. The device of claim 21, wherein the drive system comprises a motor configured to rotate a drive roll that is positioned adjacent to an idler roll, the carriage has a drive rib extending from an underside of a top-plate of the carriage, and the drive rib is positioned between and in frictional engagement with the drive roll and the idler roll.

24. The device of claim 17, wherein the carriage has an inboard support rib and an outboard support rib extending from an underside of a top-plate of the carriage, the inboard support rib being seated on and guided by the plurality of inboard rollers and the outboard support rib being seated on and guided by the plurality of outboard rollers.

25. The device of claim 16, wherein the carriage comprises a protective skirt extending from an underside of a top-plate of the carriage and configured to prevent access to the at least one plurality of rollers.

26. The device of claim 16, wherein a plurality of weldable parts are removably mounted in the first opening and the second opening and a gusset strip is positioned on and extends outwardly from a respective one of each of the plurality of weldable parts, the device comprising an inboard welding unit configured to weld one of the gusset strips to an edge of a respective one of the plurality of weldable parts on an inboard side of the plurality of weldable parts as the carrier moves on the track system, and comprising an outboard welding unit configured to weld one of the gusset strips to another edge of a respective one of the plurality of weldable parts on an outboard side of the plurality of weldable parts as the carrier moves on the track system.

27. The device of claim 26, further comprising a flux recycling system positioned adjacent to the gusset strips and configured to collect welding flux dispensed by the inboard welding unit and the outboard welding unit.

28. The device of claim 16, wherein the carriage and the plurality of weldable parts have an arcuate shape.

29. A method of welding and staging comprising:
providing the device of claim 16, at least one weld unit, gusset strips and a plurality of weldable parts; and
welding a first gusset-edge of a first gusset strip of the gusset strips to a first weld-edge of a first weldable part of the plurality of weldable parts with the first gusset-edge facing upward and the first weld-edge facing downward as the carriage moves the plurality of weldable parts along the inboard arcuate path and the outboard arcuate path.

30. The method of claim 29, further comprising:
while the plurality of weldable parts is secured in the carrier, removing the carrier from the carriage after the welding;
rolling the carrier 180 degrees about the axis of rotation so that the first gusset-edge of the first gusset strip faces downward;
replacing the carrier on the carriage with a second gusset-edge of a second gusset strip of the gusset strips that faces upwards, the second-gusset edge being opposite the first gusset-edge; and
welding the second gusset-edge to a second weld-edge of a second weldable part of the plurality of weldable parts, the second weld-edge being opposite the first weld-edge, as the carriage moves the plurality of weldable parts along the inboard arcuate path and the outboard arcuate path.
